(19) United States
(12) Patent Application Publication
(10) Pub. No.: US 2025/0201429 A1
(43) Pub. Date: Jun. 19, 2025

(54) DEVICE FOR TRAPPING DEBRIS IN A NUCLEAR FUEL ASSEMBLY

(71) Applicants: JOINT-STOCK COMPANY "TVEL" (JSC TVEL), Moscow (RU); PUBLICHNOE AKTSIONERNOE OBSHCHESTVO "NOVOSIBIRSKY ZAVOD KHIMKONTSENTRATOV" (PAO "NZHK"), Novosibirsk (RU)

(72) Inventors: Roman Sergeevich IVANOV, Novosibirsk (RU); Anatoly Alekseevich ENIN, Novosibirsk (RU); Mstislav Aleksandrovich SHUSTOV, Novosibirsk (RU); Andrey Vladimirovich MURAVIEV, Novosibirsk (RU); Sergey Aleksandrovich MYAKOV, Nizhny Novgorod (RU); Irina Evgenyevna SIMANOVSKAYA, Nizhny Novgorod (RU); Evgeny Vasilyevich SHOLIN, Novosibirsk (RU); Aleksandr Valeryevich UGRYUMOV, Moscow (RU)

(21) Appl. No.: 18/571,642

(22) PCT Filed: Jan. 10, 2022
(86) PCT No.: PCT/RU2022/000003

§ 371 Date: Jun. 20, 2024

(30) Foreign Application Priority Data
Jun. 21, 2021 (RU) 2021118331

(51) Int. Cl. G21C 3/32

(52) U.S. Cl. CPC G21C 3/3206

(57) ABSTRACT

The invention relates to a device for trapping debris in a fuel assembly of a nuclear reactor, which is mounted in the bottom nozzle of the fuel assembly. The device consists of two interconnected plate-type filter elements arranged one above the other and having channels for the passage of a coolant. In the lower filter element, the channels are inclined toward the axis of the fuel assembly, and in the upper filter element, the channels are parallel to the axis of the fuel assembly. The channels can be produced, in particular, by waterjet cutting to form slots in the field of a filter element plate, the slots being separated lengthwise by vertical ribs and widthwise by crosspieces. The vertical ribs and the crosspieces between the channels of each of the filter elements have roundings formed thereon, and a gap is provided between the vertical ribs and crosspieces formed in the plates of different filter elements. The technical result is the possibility of intercepting and trapping debris of any size contained in a coolant loop, without reducing the flow cross section for the coolant.

### TECHNICAL FIELD

The invention relates to nuclear power engineering and can be used for fuel assemblies of nuclear reactors WWER and PWR.

### BACKGROUND

An anti-debris filter for a nuclear reactor fuel assembly is known (see patent RU 2264666, publ. Nov. 20, 2005), which is a densely perforated flat plate with chevron-shaped holes 2 mm wide. The drawback of this technical solution is the small thickness of the crosspieces between the holes (0.3 . . . 0.6 mm) with a plate thickness of 6 . . . 8 mm, which leads to increased labor costs during manufacturing, as well as significant hydraulic resistance.

The closest in technical essence and achieved result to the proposed device is a filter for retaining debris in a fuel assembly of a nuclear reactor (see patent RU 2610913, publ. Feb. 17, 2017), which can be selected as a prototype, that is mounted in a bottom nozzle of the fuel assembly and consists of two plate-type filter elements arranged one above the other and containing two groups of intersecting rectilinear plates forming a series of curvilinear channels with rectangular cross-section for the passage of coolant along the fuel assembly axis, while the channels of the lower filter element are inclined toward the longitudinal axis of the fuel assembly, and the channels of the upper filter element arranged between the lower filter element and the supporting grille are parallel to the fuel assembly axis.

The drawback of this design is its high manufacturing complexity, since it consists of individual plates, and a high coefficient of hydraulic resistance.

### DISCLOSURE OF INVENTION

Technical object of the present invention is to increase reliability of fuel assemblies during their long-term operation in a nuclear reactor, reducing the coefficient of hydraulic resistance with simultaneous reducing the labor intensity of manufacturing the device.

Technical result of the present invention is to provide a device capable of intercepting and trapping debris of any size present in a coolant circuit, without decrease in flow cross section for the coolant.

The problem is solved by a device for trapping debris in a fuel assembly of a nuclear reactor, which is mounted in the bottom nozzle of the fuel assembly, the device consisting of two interconnected plate-type filter elements arranged one above the other and having channels for a coolant passage having a length and a width, wherein the channels in the lower filter element are inclined toward the axis of the fuel assembly, and the channels in the upper filter element are parallel to the axis of the fuel assembly. According to the present invention, the channels for the coolant passage are produced by waterjet cutting to form slots in the area of a filter element plate, the slots being separated lengthwise by vertical ribs and widthwise by crosspieces, wherein roundings are formed on the vertical ribs and the crosspieces between the channels for the coolant passage of each of the filter elements, and a gap is provided between the vertical ribs and crosspieces formed in the plates of different filter elements.

The problem is also solved by the roundings of the vertical ribs and crosspieces being provided on the side of the gap.

The problem is also solved by the crosspieces of the upper and lower filter elements being offset with respect to one another.

The problem is also solved by the crosspieces of the upper filter element being inclined toward the axis of the fuel assembly in the direction opposite to the incline of the channels of the lower filter element.

The proposed design of the trapping device allows to solve the object of the present invention. In operation of a fuel assembly in a nuclear reactor, the coolant flow containing debris enters the fuel assembly inlet. It is known that particles that can cause fretting wear of fuel elements claddings, are mainly fragments of wire of various sizes. When moving in a coolant flow, these particles are oriented with their long side along the current lines, that is, along the lines of less resistance. Thus, the particles move with their long axis parallel to the fuel assembly axis. When meeting a filter element having inclined channels, the particles are oriented in parallel to these channels and fall into the gap between the crosspieces of the channels of plates of different filter elements, getting stuck in them. The presence of roundings on the vertical ribs and the crosspieces between the channels reduces formation of vortices after the crosspieces, which aids in reducing the coefficient of hydraulic resistance.

Since the vortices are mainly formed in the gap between the plates, making roundings on the vertical ribs and the crosspieces only on the side of the gap therebetween allows to reduce the coefficient of hydraulic resistance of the filter element compared to the prototype.

Forming the channels for a coolant passage as slots in the plate of the filter element, for example using the waterjet cutting, makes it possible to simplify manufacture of the device for trapping debris, thereby reducing labor costs and increasing labor productivity.

Offset of the crosspieces of the upper and lower filter elements in respect to each other allows trapping of smaller particles in the coolant.

Arrangement of the crosspieces of the upper filter element inclined toward the axis of the fuel assembly in the direction opposite to the inclination of the channels of the lower filter element, allows to improve the filtering ability of the device.

Making channels from a single plate increases reliability of the filter elements and fuel assembly in general.

### BRIEF DESCRIPTION OF DRAWINGS

The essence of the invention is illustrated by the drawings.

FIG. 1 shows a perspective view of the fuel assembly of a nuclear reactor with the device for trapping debris according to the present invention:
a) WWER fuel assembly;
b) PWR fuel assembly.

FIG. 2 shows a cross-section of the device for trapping debris in a fuel assembly.

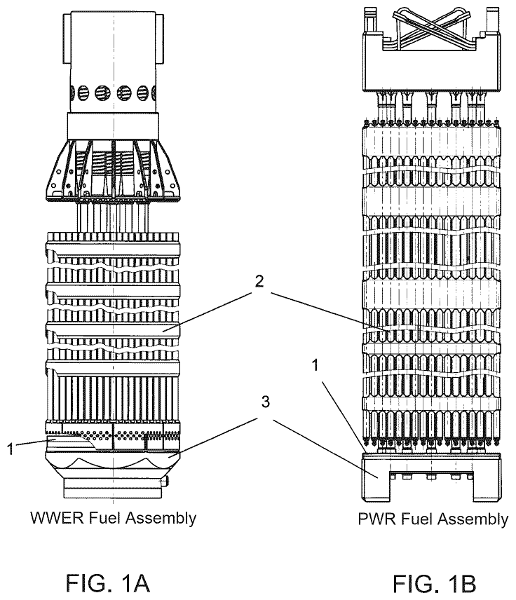

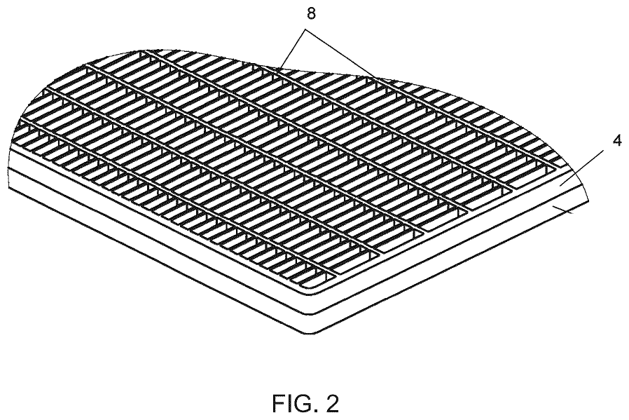

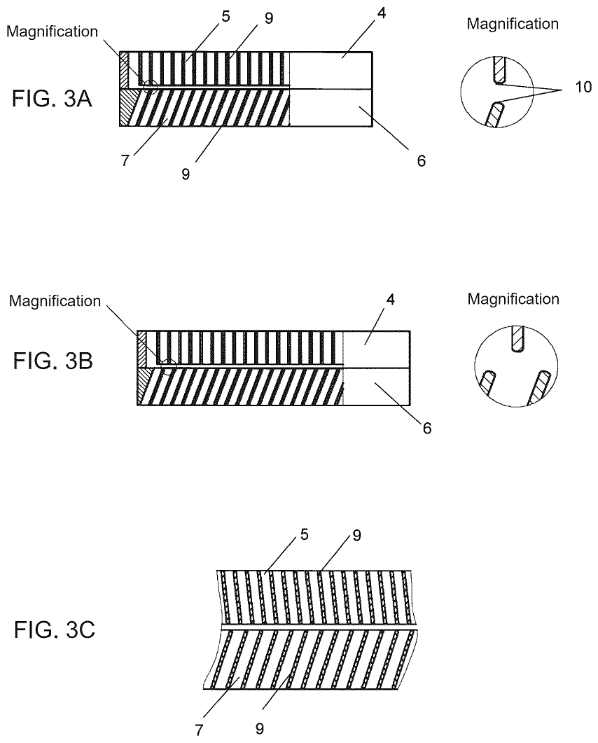

FIG. 3 shows a fragment of the device for trapping debris in a fuel assembly:
a)—with the rounding on the vertical ribs and on the crosspieces between the channels;
b)—with offset crosspieces of the upper and lower filter elements;
c)—with the crosspieces of the upper filter element inclined toward the axis of the fuel assembly.

Device (1) for trapping debris in a nuclear fuel assembly (2) is mounted in the bottom nozzle (3) of the fuel assembly (2) and comprises two interconnected plate-type filter elements as a plate (4) wherein channels (5) for a coolant passage are made parallel to the axis of the fuel assembly (2), and a plate (6) with channels (7) inclined toward the axis of the fuel assembly (2). The channels are separated lengthwise along the plates (4,6) by vertical ribs (8) and widthwise by crosspieces (9). The length of the channels is defined by a pitch between the vertical ribs (8), and width of the channels (5,7) is defined by a pitch and location of the crosspieces (9). Roundings (10) are formed on the vertical ribs (8) and the crosspieces (9). The crosspieces (9) of the upper filter element (4) can be made with an inclination to the fuel assembly axis in the direction opposite to the direction of the inclination of the channels (7) of the plate (6).

### BEST EMBODIMENT OF THE INVENTION

The device for trapping debris in a fuel assembly of a nuclear reactor operates in the following way.

The device (1) is made of two interconnected plates (4,6) arranged one above the other, wherein slots forming the channels (5,7) are made, for example, using waterjet cutting method. The slots are separated lengthwise by vertical ribs (8) and widthwise by crosspieces (9). Channels (5) of the upper plate (4) are parallel to the axis of the fuel assembly (2), and channels (7) of the lower plate (6) are inclined toward the axis of the fuel assembly (2). Roundings (10) can be formed on the vertical ribs (8) of the channels and on the crosspieces (9). A gap (not shown) is provided between the vertical ribs (8) and crosspieces (9) of the different plates. The device made in such a way is mounted in the bottom nozzle of the fuel assembly (2). During operation of the fuel assembly in the nuclear reactor the coolant flow containing debris enters an inlet of the fuel assembly (2). Particles that can cause fretting wear of the fuel elements claddings, are mainly wire fragments of various sizes. When moving in the coolant flow these particles are oriented with their long side along the current lines, that is, along the lines of less resistance. Thus, the particles move with their long axis parallel to the fuel assembly axis. When interacting with the inclined channels the particles are oriented parallel to the channels and fall into the gap between the ribs (8) and crosspieces (9) of different plates (4,6) of the trapping device. Roundings (10) provided on the ribs (8) and crosspieces (9) reduce formation of the vortices after the crosspieces, which aids in reducing the coefficient of hydraulic resistance. Making the filter elements from single plates further increases reliability of both the device and the fuel assembly in general. Inclination of the crosspieces (9) of the upper filter element (4) toward the fuel assembly axis improves filtering capacity by allowing the filter to trap debris with smaller linear dimensions.

At the end of the operation the fuel assembly (2) is unloaded from the reactor, and the debris trapped by the trapping device (1) are also removed with the fuel assembly (2).

### INDUSTRIAL APPLICABILITY

Thus, the device for trapping debris in a fuel assembly of a nuclear reactor increases reliability of the fuel assemblies during their long-term operation in a nuclear reactor, reduces the coefficient of hydraulic resistance, and reduces the labor intensity of manufacturing the device.

1. A device for trapping debris in a fuel assembly of a nuclear reactor, which is mounted in the bottom nozzle of the fuel assembly, the device consisting of two interconnected plate-type filter elements arranged one above the other and having channels for a coolant passage having a length and a width,
wherein the channels in the lower filter element are inclined toward the axis of the fuel assembly, and the channels in the upper filter element are parallel to the axis of the fuel assembly,
characterized in that the channels for the coolant passage are formed as slots in the area of a filter element plate, the slots being separated lengthwise by vertical ribs and widthwise by crosspieces,
wherein roundings are formed on the vertical ribs and on the crosspieces between the channels for the coolant passage of each of the filter elements, and a gap is provided between the vertical ribs and the crosspieces formed in the plates of different filter elements.

2. The device according to claim 1, wherein the roundings of the vertical ribs and of the crosspieces are provided on the side of the gap.

3. The device according to claim 1, wherein the crosspieces of the upper and lower filter elements are offset with respect to one another.

4. The device according to claim 1, wherein the crosspieces of the upper filter element are inclined toward the axis of the fuel assembly in a direction opposite to the incline of the channels of the lower filter element.
